(19) United States
(12) Patent Application Publication
(10) Pub. No.: US 2024/0029977 A1
(43) Pub. Date: Jan. 25, 2024

(54) Stored Program Interpreter For Implementing Time-Dependent Behavior of Controlled Loads

(71) Applicant: Astronics Advanced Electronic Systems Corp., Kirkland, WA (US)

(72) Inventor: William R. Dolson, Santa Fe, NM (US)

(73) Assignee: Astronics Advanced Clectronic Systems Corp., Kirkland, WA (US)

(21) Appl. No.: 18/357,854

(22) Filed: Jul. 24, 2023

Related U.S. Application Data
(60) Provisional application No. 63/391,688, filed on Jul. 22, 2022.

(51) Int. Cl. H01H 43/04; G06F 9/38; G06F 9/32; G06F 9/30

(52) U.S. Cl. CPC H01H 43/04; G06F 9/3802; G06F 9/321; G06F 9/30094

(57) ABSTRACT

A stored program interpreter or virtual machine with a reduced or simple instruction set that implements a Sequencer which allows the programming of time-dependent behavior of controlled loads or circuits such as Electronic Circuit Breaker Units (ECBUs). Programs can be dynamically loaded or modified at run-time, allowing ensemble behavior of controlled loads, such as wig-wag or de-ice heat cycling, to be implemented without a change to the embedded firmware application code.

### CROSS REFERENCE TO RELATED APPLICATIONS

This application claims the benefit of priority to U.S. Provisional Application Ser. No. 63/391,688 filed on Jul. 22, 2023, the entire contents of which are incorporated by reference herein.

### FIELD OF THE INVENTION

The present invention generally relates to a stored program interpreter or virtual machine with a reduced or simple instruction set that implements a Sequencer which allows the programming of time-dependent behavior of controlled loads or circuits such as Electronic Circuit Breaker Units (ECBUs).

### BACKGROUND OF THE INVENTION

Generally, two methods are available for programmatic control of ECBUs, Cycle Control and Advanced Sequencer Control. In the context of the present technology, a coordinated set is a group of one or more breakers with the first breaker in the set being considered the primary breaker. A primary breaker may be assigned to only one of these Control Methods. If that primary breaker is a member of a coordinated set, then all secondary breakers in the set are also governed by that Control Method.

Cycle Control provides for the on-off cycling in unison of all the breakers in a coordinated set. A primary breaker is configured to be controlled by the Cycle Program. A Cycle-Time-On and Cycle-Time-Off in seconds are specified for that Cycle Control. When the primary breaker is sent an on command, e.g., by a Display, the Cycle Program is activated, which turns on all members of the coordinated set. They remain on for a time period equivalent to Cycle-Time-On. The Cycle Program then turns off the coordinated set and it remains off for the time period equivalent to Cycle Time Off. The Cycle Program then turns on the set and the process repeats continuously. The Cycle Program remains active until an off command is sent for the primary breaker by the Display. No matter whether the primary breaker is in the Cycle-Time-On or the Cycle-Time-Off of the Cycle, the Cycle Program is terminated and the primary breaker and any associated breaker in the set is turned off if they are on.

Sequencer Control provides user programmable control of the individual breakers in a coordinated set via Sequencer instructions. Individual breakers in the set may be turned on and off in an arbitrary or non-arbitrary sequence with programmable delays between on and off states. A given sequence may be repeated a selected number of times or may be repeated continuously.

### BRIEF SUMMARY OF THE INVENTION

The present invention generally relates to a stored program interpreter or virtual machine with a reduced or simple instruction set that implements a Sequencer which allows the programming of time-dependent behavior of controlled loads or circuits such as Electronic Circuit Breaker Units (ECBUs). Programs can be dynamically loaded or modified at run-time, allowing ensemble behavior of controlled loads, such as wig-wag or de-ice heat cycling, to be implemented without a change to the embedded firmware application code.

The above and other elements, features, steps, characteristics and advantages of the present invention will become more apparent from the following detailed description of the preferred embodiments with reference to the attached drawings.

### DESCRIPTION OF DRAWINGS

FIGS. 1A, 1B, and 1C are flowcharts illustrating the operation of a stored program interpreter according to an embodiment of the present invention.

### DETAILED DESCRIPTION OF THE INVENTION

Hereinafter, preferred embodiments of the present invention will be described in detail with reference to the drawings. Note that identical or corresponding elements in the drawings will be denoted by the same reference numerals and descriptions thereof will not be repeated.

Generally, two methods are available for programmatic control of ECBUs, Cycle Control and Advanced Sequencer Control. A coordinated set is a group of one or more breakers with the first breaker in the set being considered the primary breaker. A primary breaker may be assigned to only one of these Control Methods. If that primary breaker is a member of a coordinated set then all secondary breakers in the set are also governed by that Control Method.

### Cycle Control

Cycle Control provides for the on-off cycling in unison of all the breakers in a coordinated set. A primary breaker is configured to be controlled by the Cycle Program. A Cycle-Time-On and Cycle-Time-Off in seconds are specified for that Cycle Control. When the primary breaker is sent an on command, e.g., by a Display, the Cycle Program is activated, which turns on all members of the coordinated set. They remain on for a time period equivalent to Cycle-Time-On. The Cycle Program then turns off the coordinated set and it remains off for the time period equivalent to Cycle Time Off. The Cycle Program then turns on the set and the process repeats continuously. The Cycle Program remains active until an off command is sent for the primary breaker by the Display. No matter whether the primary breaker is in the Cycle-Time-On or the Cycle-Time-Off of the Cycle, the Cycle Program is terminated and the primary breaker and any associated breaker in the set is turned off if they are on.

### Advanced Sequencer Control

Sequencer Control provides user programmable control of the individual breakers in a coordinated set via Sequencer instructions. Individual breakers in the set may be turned on and off in an arbitrary or non-arbitrary sequence with programmable delays between on and off states. A given sequence may be repeated a selected number of times or may be repeated continuously.

In an embodiment, the Sequencer allows customizing the programming of load controllers, such as ECBUs, without modifying the application firmware.

Sequencer Control provides user programmable control of the breakers in a coordinated set of breakers via Sequencer instructions. A coordinated set is a group of one or more breakers with the first breaker in the set being considered the primary breaker. Individual breakers in the set may be turned on and off in an arbitrary or non-arbitrary sequence with desired programmable delays between on and off instructions. A given sequence may be repeated a fixed number of times or alternatively may be executed continuously. In an alternative embodiment, instead of simply turning on and off breakers or other elements, the Sequencer Control may provide proportional control whereby a breaker or another element may be turned on or off partially, in a range from 0-100%. For example, it may be desired to have a particular breaker or element not fully turn on and/or not fully turn off, for example, it may be controlled to range from 10% on to 90% on. Of course, either of the endpoints of the range may be zero, such that a breaker or element, for example, may be controlled to range from OFF (0%) to 50%, or from 50% to ON (100%).

In general, the sequencer may be a simple virtual machine which allows a user to provide input by bay of textual messages or instructions. For example, possible textual messages or instructions may include the following instructions:
ON (breaker #)
OFF (breaker #)
WAIT (time in tenths of a second up to 24 hours)
REPEAT (number of times or 0 for continuously)
END

The Sequencer program is associated with the primary breaker in a coordinated set. The breaker number in all ON and OFF instructions is that of a member of the particular coordinated set.

By way of example, if breakers 1 and 2 comprise a coordinated set, where breaker 1 is the primary breaker, the following Sequencer Program will alternately toggle breakers 1 and 2 off and on every 4 seconds:
OFF 1
ON 2
WAIT 40
OFF 2
ON 1
WAIT 40
REPEAT 0

The above program is started by turning on breaker 1 via a remote control device. Note that since this coordinated set is under Sequencer control, the command from the Display does not result in breaker 1 being turned on, but rather results in the sequencer program being run. In fact, the Sequencer Program listed above turns off breaker 1 and then turns on breaker 2. Note that this program implements break before make on the two breakers since the OFF and ON commands are guaranteed to be executed in program order. Since the Sequencer program repeats continuously, it is turned off by sending an off command to the primary breaker from the remote control device. Turning off the Sequencer program in this fashion turns off all the breakers in the coordinated set.

Sequencer programs are loaded via extensions to remote control protocols which provide the ability to add, remove, or modify Sequencer programs. Sequencer programs are typically stored in flash memory not used by the embedded firmware application.

The Display or some other controller provides the ability to create or edit a Sequencer Program. Sequencer Programs are set at the Main ECBU (MECBU) similarly to ECB configurations. They can also be retrieved from the MECBU for editing purposes. Sequencer programs are transferred as a block of ASCII characters. One Sequencer instruction is permitted per line followed by the optional data field, delimited by a space. An EOL character terminates every line and an EOT character terminates the block.

It may be preferable to support some sort of Display tally or annunciator on the primary or all members of a coordinated set which is configured with a Cycle or Sequencer Program and also to indicate when the Program is active. In this way the user would be aware that a breaker which is currently off might be turned on under program control at some point in the future. Also this would indicate that turning on a primary breaker under Sequencer control might not result in that breaker turning on immediately.

The scripts for the Sequencer Programs may be stored as variable length binary instructions, instead of text, in order to save memory space.

When a Sequencer Program is loaded into the ECBU the text Instructions are converted to binary codes and stored in Sequencer program memory elements within the Sequencer program storage area.

The maximum number of sequencer programs for an ECBU may be equal to the total number of circuit breakers as the minimum number of breakers in a coordinated set is one.

Each Sequencer program requires a Run Flag, a Program Counter, a Wait Counter, a Loop Counter, and a Loop Flag.

Sequencer Programs are run by turning on the primary breaker in a coordinated set which sets the Run Flag to True. Turning off the primary breaker sets the Run Flag to False.

By way of example, the Sequencer Processor is run every tenth of a second. Each stored sequencer program is examined in every run pass.

In an embodiment, the processing steps for a particular program are as follows:
IF the Program Run Flag is True:
IF the Wait Counter is nonzero the program is in a wait period and the counter is decremented and no further action taken for that program on this pass.
IF the Program Counter is out of bounds the program is stopped by setting the Run Flag to False.
IF the Loop Count is incremented and is >1, indicating an infinite loop, the program is stopped by setting the Run Flag to False.

The next instruction is fetched from the program storage and that instruction is decoded as follows:

IF the instruction is a NOP (no operation) the Program Counter is simply incremented.
ELSE IF the instruction is an ON command, the next program memory element, specifying the breaker number to be turned on, is retrieved.
   IF that breaker is an element of the coordinated set, it is turned on and the Program Counter incremented.
ELSE IF the instruction is an OFF command, the next program memory element, specifying the breaker number to be turned off, is retrieved
   IF that breaker is an element of the coordinated set, it is turned off and the Program Counter incremented.
ELSE IF the instruction is a WAIT, the next three program memory elements are retrieved which specify the wait time. The Program Counter is incremented by four.
   IF the wait time is zero, execution of the program is suspended by setting the Run Flag to False.
   ELSE the Wait Counter is loaded with the wait time and the program begins the wait period.
ELSE IF the instruction is a REPEAT,
   If the Loop Flag is True, the Loop Count is decremented
      IF the Loop Count is now zero, indicating the number of loop passes has occurred, the Program Counter is incremented to the next instruction after the Loop Count.
      ELSE the Program Counter is reset to the program start.
   ELSE the Loop Flag is False, indicating the beginning of a loop, the Loop Count is retrieved from the next two program memory elements and the Program Counter is reset to the Program Start.
ELSE IF the instruction is an END the Run Flag is set to False.

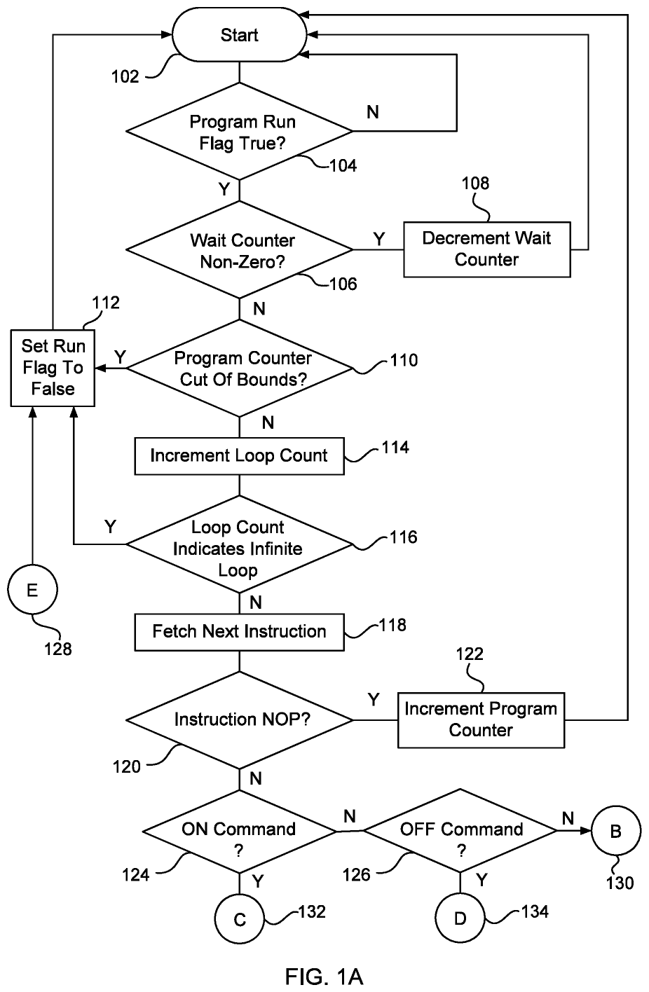

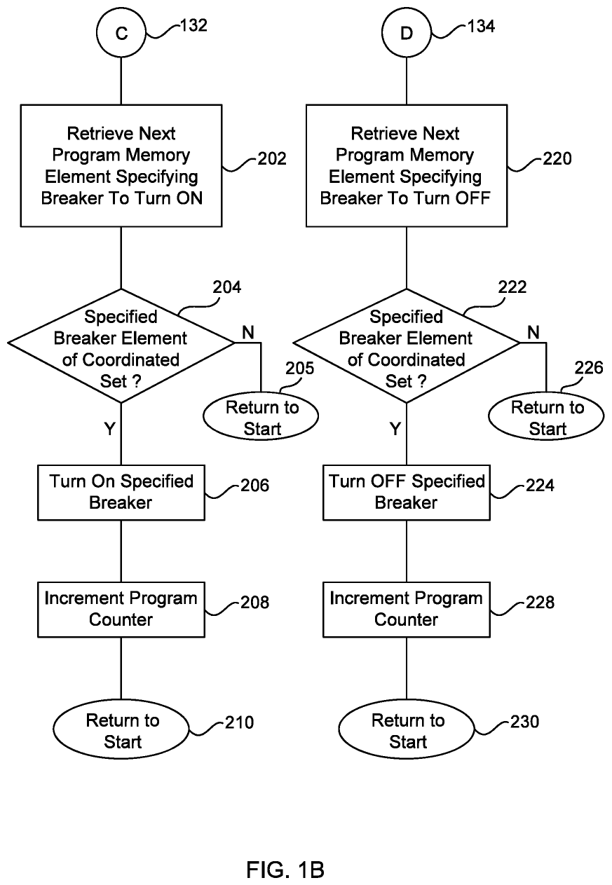

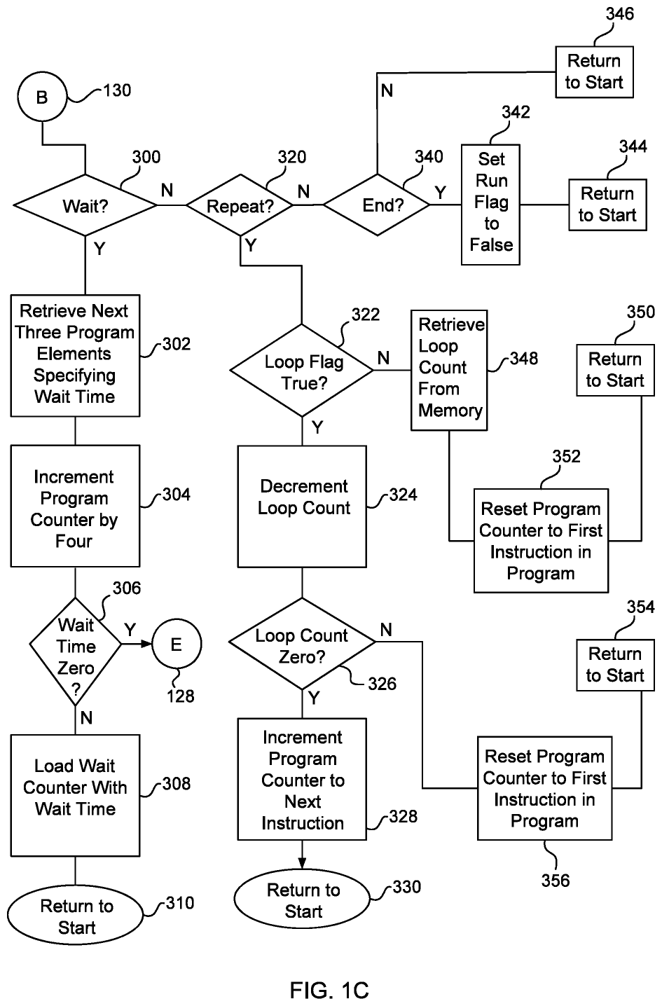

The processing steps for the above program are illustrated in FIGS. 1A, 1B, and 1C. Referring now to FIG. 1A, the program begins at Step 102 (Start). Next, at Step 104 a check is made to see if the Program Run Flag is True. If the Program Run Flag is true, processing continues to Step 106. Otherwise, processing returns to Step 102 (Start) to further check if the Program Run Flag is true. At step 106 a check is made to see if the Wait Counter is nonzero. If the Wait Counter is nonzero, then the program is in a wait period and processing continues to Step 108, where the Wait Counter is decremented and processing returns to Step 102 (Start). If the Wait Counter is not nonzero, then the processing alternatively proceeds to Step 110.

At Step 110, a check is made to see if the Program Counter is out of bounds, and if it is, then the program is stopped by setting the Run Flag to False (Step 112). From Step 112, the program returns back to Step 102 (Start). If the Program Counter is not out of bounds, processing proceeds to Step 114 the Loop Count is incremented. Next, processing proceeds to Step 116 and a check is made to see if the Loop Count indicates an infinite loop. If at Step 116, an infinite loop is indicated, then processing proceeds to Step 112, the Run Flag is set to false, and then processing goes back to Step 102 (Start).

If at Step 116, an infinite loop is not indicated, then processing proceeds to Step 118 and the next instruction is fetched from program storage and that instruction is decoded. Next, at Step 120 a check is made to see if the instruction is a NOP (no operation). If the instruction is determined to be a NOP, then processing proceeds to Step 122 and the Program Counter is incremented, and the program then proceeds to Step 102 (Start).

After Step 120, if the instruction is determined to not be a NOP, then processing continues to Step 124 where it is determined if the instruction is an ON command. If the instruction is an ON command, then processing proceeds to Step 202 (see FIG. 1B) where the next program memory element is retrieved specifying the breaker to be turned ON. Alternatively, if at Step 124 it is determined that the instruction is not an ON command, then processing continues to Step 126 where it is determined whether the instruction is an OFF command. If at Step 126 it is determined that the instruction is an OFF command, the program continues to Step 220 (See FIG. 1B) in order to retrieve the next program memory element specifying the breaker number to be turned OFF. If at Step 126 it is determined that the instruction is not an OFF command, then processing continues to Step 300 (See FIG. 1C).

From Step 202 processing continues to Step 204 where it is determined whether the breaker is an element of the coordinated set. If the breaker is an element of a coordinated set, then processing proceeds to Step 206 and the specified breaker is turned ON and the Program Counter is incremented (Step 208). From Step 208, the program returns back to Step 102 (Start) to repeat processing again.

At Step 220 (once it is determined that the instruction is an OFF command), the next program memory element, specifying the breaker number to be turned off, is retrieved at Step 220. From Step 220, a determination is made at Step 222 to determine whether the specified breaker is an element of the coordinated set. If the specified breaker is an element of the coordinated set, then the breaker is turned off (Step 224) and the Program Counter incremented (Step 228). After Step 228, the processing returns to Step 102 (Start) to repeat processing again.

If instead it was determined that instruction was not an ON command and was not an OFF command, then processing continues to Step 300 to determine whether the instruction is a WAIT command. If at Step 300 it is determined that the instruction is a WAIT command, then processing continues to Step 302, and the next three program memory elements are retrieved which specify the wait time. From Step 302, processing continues to Step 304 where the Program Counter is incremented by four.

From Step 304, the program continues to Step 306 to determine if the wait time is zero, and if the wait time is zero, then processing returns to Step 112 (FIG. 1A) and the run flag is set to False to suspend execution of the program and processing continues further back to Step 102 (Start). execution of the program is suspended by setting the Run Flag to False.

Alternatively, if at Step 306 it is determined that the Wait time is not zero, then processing continues to Step 308 and the Wait Counter is loaded with the wait time and the program begins the wait period, and after the Wait period, processing returns back to Step 102 (Start).

Alternatively, if at Step 300 it is determined that the instruction is not a Wait command, then processing continues to Step 320 to determine whether the instruction is a Repeat command. If the instruction is determined to be a Repeat command, then processing continues to Step 322 where a check is made to see if the Loop Flag is True. If the Loop Flag is True, the Loop Count is decremented (Step 324) and processing continues to Step 326 to determine whether the Loop Count is zero. If the Loop Count is now zero, indicating the number of loop passes has occurred, the Program Counter is incremented to the next instruction after the Loop Count (Step 328). After this, the processing goes back to Step 102 (Start) and the Program Counter is reset to the program start. If the Loop Count is not zero, then processing continues to Step 356 and the Program Counter is reset to the first instruction in the program. From Step 356, processing continues to Step 354 and then back to Start (Step 102).

If at Step 322 it was determined that the Loop Flag is False, indicating the beginning of a loop, the Loop Count is retrieved from the next two program memory elements (Step 348) and the Program Counter is reset to the Program Start, i.e., the first instruction in the program (Step 352) and processing then goes to Step 350 and then to Start (Step 102).

If at Step 320 it is determined that the instruction is not a Repeat instruction, then processing continues to Step 340. At Step 340, a check is made to determine whether the instruction is an END instruction. If the instruction is an END instruction, then processing continues to Step 342, the Run flag is set to False, and the program returns to Start (via Step 344). If instead at Step 340 itis determined that the instruction is not an END instruction, then processing returns back to Start (Step 102) for processing the next instruction.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stored program interpreter for implementing time-dependent behavior of controlled loads, comprising:
an input for receiving a user selection for controlling a load device;
an output for selectively controlling an electronic switch associated with the load device to allow selective activation or deactivation of the load device;
a processor and a memory containing instructions, which when executed by the processor cause the processor to:
determine if a Program Run Flag is True;
executing the selected activation or deactivation of the switch;
determine any amount of wait time to be performed;
determine a number of repeat sequences to be performed; and
execute the specified number of repeat sequences.

2. The stored program interpreter of claim 1, further comprising determining if the electronic switch to be activated or deactivated is an element of a coordinated set of elements, and if the electronic switch to be activated or deactivated is an element of the coordinated set of elements, then executing the selected activation or deactivation for all elements of the coordinated set of elements.

3. The stored program interpreter of claim 1, further comprising activating a primary breaker of the coordinated set of elements, wherein the primary breaker includes an electronic circuit breaker unit.

4. The stored program interpreter of claim 1, wherein each repeat sequence further comprises activating the switch for a predetermined on time and deactivating the switch for a predetermined off time.

5. The stored program interpreter of claim 1 wherein the repeat sequences are executed until an off command is received.

6. The stored program interpreter of claim 5, further comprising deactivation of the switch based on receiving an off command.

7. The stored program interpreter of claim 3, further comprising selectively activating and deactivating each element of the coordinated set of elements.

8. The stored program interpreter of claim 1, wherein the activation and deactivation of the switch further comprises proportional control whereby the switch is partially turned on or off in a range from 0 to 100%.

9. A stored program interpreter for implementing time-dependent behavior of controlled loads, comprising:
an input for receiving a user selection for controlling a load device;
an output for selectively controlling an electronic switch associated with the load device to allow selective activation or deactivation of the load device;
a processor and a memory containing instructions, which when executed by the processor cause the processor to:
determine whether a Program Run Flag is True, and if the Program Run Flag is True, a determination is made as to whether a Wait Counter is nonzero, otherwise, a further check is made if the Program Run Flag is True;
if the Wait Counter is determined to be nonzero, then the Wait Counter is decremented one or more times, each time followed by a further check to determine if the Wait Counter is nonzero;
if the Wait Counter is not nonzero, then a check is made to see if the Program Counter is out of bounds, and if it is, then the program is stopped by setting a Run Flag to False, otherwise a Loop Count is incremented and a check is made to see if the Loop Count indicates an infinite loop which then causes the Run Flag to be set to false;
when an infinite loop is not indicated, a next instruction is fetched from program storage and when the instruction is determined to be a NOP (no operation) a Program Counter is incremented;
when the instruction is determined to not be a NOP, it is then determined if the instruction is an ON command which retrieves a next program memory element specifying the switch to be turned ON.

10. The stored program interpreter of claim 9, wherein the processor is further programmed to:
determine that the instruction is not an ON command, and then further determine whether the instruction is an OFF command;
when it is determined that the instruction is an OFF command, a next program memory element is retrieved specifying the switch number to be turned OFF, a determination is made as to whether the specified switch is an element of the coordinated set, and if it is, then the switch is turned off and the Program Counter incremented.

11. The stored program interpreter of claim 9, wherein the processor is further programmed to:
determine whether the switch is an element of a coordinated set, and if it is, then the specified switch is turned ON and the Program Counter is incremented.

12. The stored program interpreter of claim 10, wherein the processor is further programmed to:
determine that the instruction was not an ON command and was not an OFF command, then determine whether the instruction is a WAIT command, and if it is a WAIT command, the next three program memory elements are retrieved which specify the wait time.

13. The stored program interpreter of claim 12, wherein the processor is further programmed to:
execute the wait time until it reaches zero, and then the run flag is set to False to suspend further processing.

14. The stored program interpreter of claim 12, wherein the processor is further programmed to:
determine whether the instruction is a Repeat command, and if so, then checking to determine if a Loop Flag is True, and if it is, then a Loop Count is decremented until it reaches zero, then a Program Counter is incremented to the next instruction after the Loop Count.

15. The stored program interpreter of claim 14, wherein the processor is further programmed to:
determine that the Loop Flag is False, and then the Loop Count is retrieved and the Program Counter is reset to Program Start.

16. The stored program interpreter of claim 15, wherein the processor is further programmed to:
determine that the instruction is not a Repeat instruction, and then determine whether the instruction is an END instruction, and if it is an END instruction, then the Run flag is set to False, and the program returns to Start.
